(19) United States
(12) Patent Application Publication
(10) Pub. No.: US 2009/0284883 A1
(43) Pub. Date: Nov. 19, 2009

(54) ELECTRONIC DEVICE HAVING ELECTROSTATIC DISCHARGE PROTECTION DEVICE AND METHODS OF FABRICATING THE SAME

(75) Inventors: Hee-Seok LEE, Yongin-si (KR); Yun-Seok Choi, Hwaseong-si (KR); Kyoung-Sei Choi, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/468,178

(22) Filed: May 19, 2009

(30) Foreign Application Priority Data
May 19, 2008 (KR) 2008-0045979

(51) Int. Cl. H02H 9/00

(52) U.S. Cl. 361/56

(57) ABSTRACT

An electronic device having an electrostatic discharge (ESD) protection device and methods of fabricating the same. The electronic device can include an electronic element to be protected from electrostatic discharge. The electronic element can be installed on a substrate. The substrate can include a ground electrode disposed on the substrate, and a first element electrode disposed at a different level from the ground electrode on the substrate to overlap a part of the ground electrode and to electrically connect to the electronic element installed to the substrate. A dielectric layer can be disposed between the ground electrode and the first element electrode, wherein the ground electrode, the first element electrode and the dielectric layer disposed therebetween constitute an electrostatic discharge (ESD) protection device.

### CROSS-REFERENCE TO RELATED APPLICATIONS

This application claims the benefit of Korean Patent Application No. 10-2008-0045979, filed on May 19, 2008, the contents of which are hereby incorporated herein by reference in their entirety.

### BACKGROUND

1. Field of the Invention

Example embodiments of the present general inventive concept relate to an electronic device, and more particularly, to an electronic device having an electrostatic discharge protection device and methods of fabricating the same.

2. Description of the Related Art

Electrostatic discharge (“ESD”) may cause a sudden and momentary electric current beyond the operation range of a semiconductor device to be generated. Also, ESD may cause an electronic device and/or an electronic system to malfunction or to make errors. In addition, ESD may cause junction breakdown, dielectric breakdown, metallization melting, etc., and as a result, an electronic device may have deteriorated performance. ESD may also cause a failure of an element constituting the electronic device.

### SUMMARY

Example embodiments of the present general inventive concept provide an electrostatic discharge (ESD) protection device that does not increase a flat size of an electronic device, an electronic device employing the same, and methods of fabricating the same.

Additional embodiments of the present general inventive concept will be set forth in part in the description which follows and, in part, will be obvious from the description, or may be learned by practice of the general inventive concept.

According to an example embodiment of the present general inventive concept, there is provided an electronic device having an electrostatic discharge (ESD) device. The electronic device can include a substrate having a first element to be protected from electrostatic discharge. A ground electrode may be provided on the substrate. A first element electrode can be disposed at a different level from the ground electrode on the substrate to overlap a part of the ground electrode, and the first element electrode can be electrically connected to the first element. A first dielectric layer can be disposed between the ground electrode and the first element electrode, wherein the ground electrode, the first element electrode and the first dielectric layer disposed therebetween can form an electrostatic discharge (ESD) protection device to connect the first element to ground when an ESD is applied to the first element.

The dielectric layer may include a polymer material.

A second element electrode can be disposed at the same level as the first element electrode, and the second element electrode can be spaced apart from the first element electrode to overlap a part of the ground electrode with the first dielectric layer interposed therebetween. The second element electrode may be electrically connected to a second element to be protected from electrostatic discharge in the substrate, and the second element electrode, the ground electrode, and the first dielectric layer disposed therebetween can constitute a second ESD protection device.

The first element electrode may include a first region having a first width and a second region having a second width greater than the first width, and the second element electrode may include a third region having a third width and a fourth region having a fourth width greater than the third width, wherein the second width may be different from the fourth width.

The ground electrode may be disposed at a higher level than the first element electrode.

The electronic device may further include a third element electrode disposed at a higher level than the ground electrode and configured to overlap a part of the ground electrode, and a second dielectric layer disposed between the third element electrode and the ground electrode. The third element electrode may be electrically connected to a third element to be protected from electrostatic discharge in the substrate, and the third element electrode, the ground electrode and the second dielectric layer may constitute a third ESD protection device.

The second dielectric layer may include the same material as the first dielectric layer.

The second dielectric layer may have the same thickness as the first dielectric layer.

The first element electrode may overlap the third element electrode with the ground electrode interposed therebetween.

The first element electrode may constitute a top metal interconnection of the first element.

The first element electrode may be disposed at a higher level than the ground electrode.

A ground redistribution unit may be disposed at the same level as the first element electrode. The ground redistribution unit may be electrically connected to the ground electrode through a contact portion configured to pass through the first dielectric layer.

A first element redistribution unit can be disposed at the same level as the ground electrode. The first element redistribution unit may be electrically connected to the first element electrode through a contact portion configured to pass through the first dielectric layer

According to another example embodiment of the present general inventive concept, there is provided a method of fabricating an electronic device including an electrostatic discharge (ESD) protection device having a ground electrode disposed at a higher level than an element electrode. The method can include preparing a substrate including one or more elements to be protected from electrostatic discharge. One or more first element electrode structures electrically connected to the element can be formed on the substrate. A first dielectric layer can be formed on the substrate having the first element electrode structure. A ground electrode structure configured to overlap a part of the first element electrode structure can be formed on the first dielectric layer, wherein the ground electrode structure, the first element electrode structure, and the first dielectric layer disposed therebetween can form a first electrostatic discharge (ESD) protection device to connect the first element to ground when the ESD is applied to the first element. A passivation layer can be formed on the substrate having the ground electrode.

The method may further include forming a ground redistribution unit on the substrate while the first element electrode structure is being formed. The ground redistribution unit may be electrically connected to the ground electrode structure through a contact portion of the ground electrode structure, the contact portion being configured to pass through the first dielectric layer.

Before forming the passivation layer, the method may further include forming a second dielectric layer on the ground electrode structure, and forming a second element electrode structure on the second dielectric layer to overlap a part of the ground electrode structure. The ground electrode structure, the second element electrode structure, and the second dielectric layer disposed therebetween may constitute a second electrostatic discharge (ESD) protection device to connect the one or more elements to ground when the ESD is applied to the one or more elements.

The second element electrode structure may be formed to have a portion configured to overlap the first element electrode structure.

The substrate may include a plurality of chip regions and a scribe lane region therebetween, wherein each of the chip regions may be a region where the element to be protected from electrostatic discharge and the ESD protection device are disposed.

The chip regions of the substrate may be separated by sawing the substrate along the scribe lane region.

According to still another example embodiment of the present general inventive concept, there is provided a method of fabricating an electronic device including an electrostatic discharge (ESD) protection device having an element electrode disposed at a higher level than a ground electrode. The method can include preparing a substrate including an element to be protected from electrostatic discharge. A ground electrode structure can be formed on the substrate. A dielectric layer can be formed on the substrate having the ground electrode structure. One or more element electrode structures can be formed on the dielectric layer. A passivation layer can be formed on the substrate having the element electrode structure.

The method may further include forming a ground redistribution unit having a contact portion configured to pass through the dielectric layer to electrically connect to the ground electrode structure on the dielectric layer while the element electrode structure is being formed.

The substrate may include a plurality of chip regions and a scribe lane region therebetween, wherein each of the chip regions may be a region where the element to be protected from electrostatic discharge and the ESD protection device are disposed.

The method may further include separating the chip regions of the substrate by sawing the substrate along the scribe lane region.

According to another embodiment of the present general inventive concept, there is provided an electrostatic discharge protection device, including a ground electrode disposed on a first level of a substrate, a first element electrode disposed on a second level of the substrate different from the first level and having a first part to overlap a portion of the ground electrode and a second part to electrically connect to one or more electronic elements installed to the substrate, and a first dielectric layer disposed between the ground electrode and the first element electrode to connect the one or more electronic components to ground when a charge beyond a predetermined range is applied to the one or more electronic elements.

The device may further include a second element electrode disposed at a different level from the first element electrode and the ground electrode and having a first part to overlap a portion of the ground electrode and a second part to electrically connect to another electronic element installed to the substrate, and a second dielectric layer disposed between the ground electrode and the second element electrode to connect the another electronic element to ground when a charge beyond a predetermined range is applied to the another electronic element.

At least a portion of the first and second element electrodes can overlap each other.

The second part can be electrically connected to an input/output (I/O) pad of the substrate to connect the one or more electronic elements.

The first part can have a polygon or circular shape and the second part can have a linear shape, wherein a width of the second part can be less than a width of the first part.

The device may further include a signal path disposed on the substrate to input or output a signal to the one or more electronic elements, wherein the signal path is disposed away from the ground electrode, the first element electrode, and the first dielectric layer.

Another example embodiment of the present general inventive concept can provide a method of fabricating an electrostatic discharge protection device, the method including forming a ground electrode on a first level of a substrate, forming a first element electrode on a second level of the substrate different from the first level, the first element electrode having a first part to overlap a portion of the ground electrode and a second part to electrically connect to one or more electronic elements installed to the substrate, and forming a first dielectric layer between the ground electrode and the first element electrode to connect the one or more electronic components to ground when a charge beyond a predetermined range is applied to the one or more electronic elements.

The method may further include forming a second element electrode at a different level from the first element electrode and the ground electrode, the second element electrode having a first part to overlap a portion of the ground electrode and a second part to electrically connect to another electronic element installed to the substrate, and forming a second dielectric layer between the ground electrode and the second element electrode to connect the another electronic element to ground when a charge beyond a predetermined range is applied to the another electronic element.

The method may further include forming a signal path on the substrate to input or output a signal to the one or more electronic elements, wherein the signal path is disposed away from the ground electrode, the first element electrode, and the first dielectric layer.

### BRIEF DESCRIPTION OF THE DRAWINGS

These and/or other embodiments of the present general inventive concept will become apparent and more readily appreciated from the following description of the embodiments, taken in conjunction with the accompanying drawings of which:

FIG. 1 is a plan view of a part of an electronic device according to example embodiments of the present general inventive concept;

FIG. 2 is a plan view of a region A of FIG. 1;

FIG. 3 is a cross-sectional view taken along line I-I′ of an electronic device according to the example embodiment of FIG. 2;

FIG. 4 is a cross-sectional view of an electronic device according to another example embodiment of the present general inventive concept;

FIG. 5 is a cross-sectional view of an electronic device according to still another example embodiment of the present general inventive concept;

FIG. 6 is a plan view of an electronic device according to yet other example embodiments of the present general inventive concept;

FIG. 7 is a cross-sectional view of an electronic device according to yet other example embodiments of the present general inventive concept;

FIG. 8 is a plan view of an electronic device according to yet other example embodiments of the present general inventive concept; and

FIG. 9 is a cross-sectional view of an electronic device according to yet other example embodiments of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

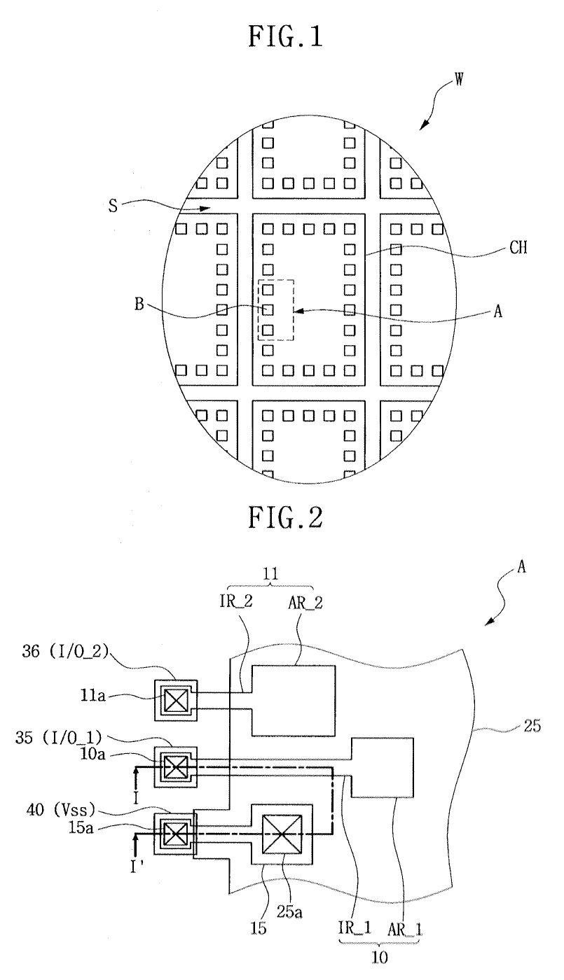

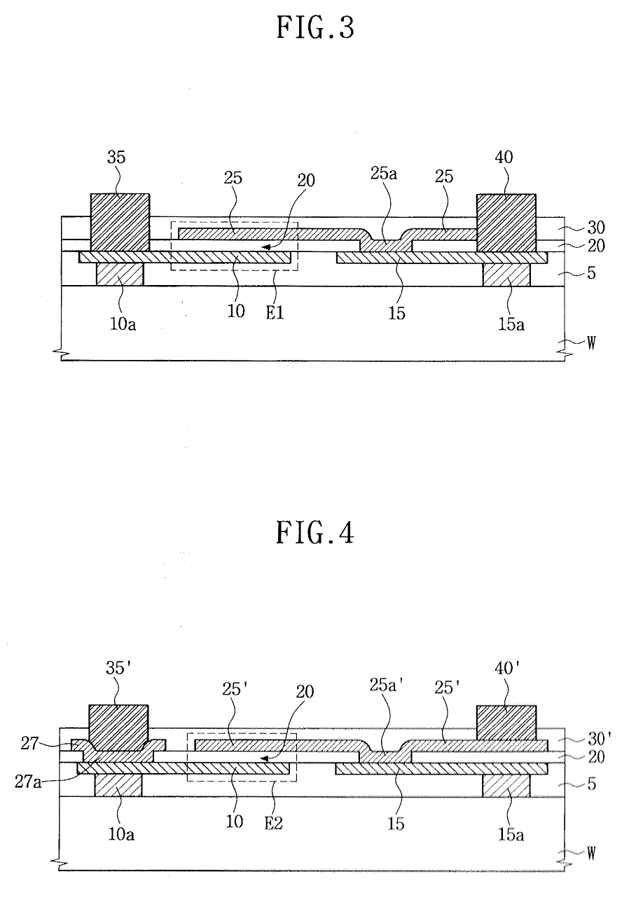

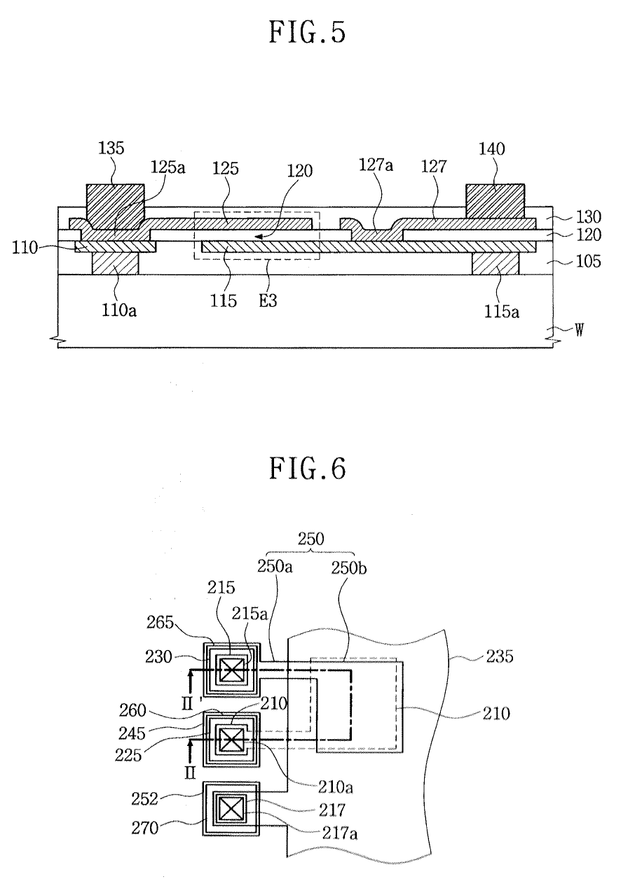

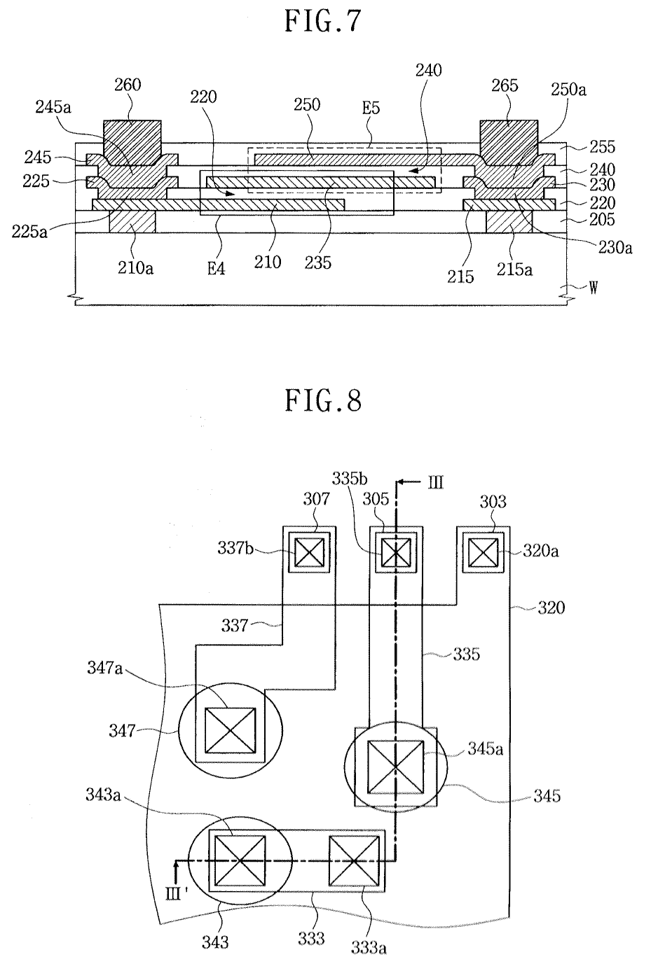

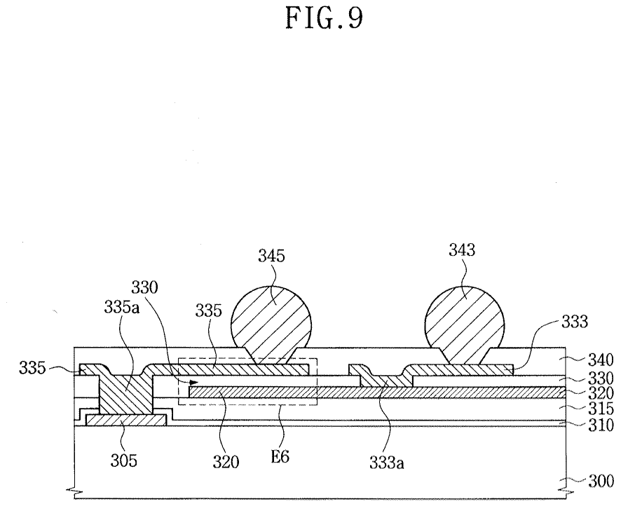

FIG. 1 is a plan view of an electronic device according to example embodiments of the present general inventive concept, FIG. 2 is a plan view of region A of FIG. 1, FIG. 3 is a cross-sectional view taken along line I-I′ of FIG. 2, FIG. 4 is a cross-sectional view of an electronic device according to another example embodiment, FIG. 5 is a cross-sectional view of an electronic device according to still another example embodiment, FIG. 6 is a plan view of an electronic device according to yet other example embodiments, FIG. 7 is a cross-sectional view taken along line II-II′ of FIG. 6, FIG. 8 is a plan view of an electronic device according to yet other example embodiments, and FIG. 9 is a cross-sectional view taken along line III-III′ of FIG. 8.

An electronic device according to example embodiments of the present general inventive concept may include electrodes disposed at different levels and an electrostatic discharge (“ESD”) protection device including a dielectric layer disposed therebetween, as described in more detail below.

Referring to FIGS. 2 and 3, an electronic device according to an example embodiment of the present general inventive concept can include a substrate W including one or more elements to be protected from electrostatic discharge may be provided. The substrate W may be a semiconductor wafer where integrated circuits can be formed or may be a wafer where one or more electronic chips (e.g. chip regions CH) can be formed. The integrated circuits or electronic chips may include elements to be protected from electrostatic discharge.

As illustrated in FIGS. 2 and 3, an insulating layer 5 may be provided on the substrate W. Element electrode structures 10 and 11, and a ground redistribution unit 15 may be provided on the insulating layer 5. The ground redistribution unit 15 may be electrically connected to a ground region of the substrate W through a contact portion 15a passing through the insulating layer 5. Likewise, the first and second element electrode structures 10 and 11 may be electrically connected to elements to be protected from electrostatic discharge in the substrate W through contact portions 10a and 11a passing through the insulating layer 5.

In the example embodiments, the first and second element electrode structures 10 and 11 and the ground redistribution unit 15 may be final metal interconnections of integrated circuits formed on a silicon wafer.

As illustrated in FIG. 3, a dielectric layer 20 may be provided on the substrate having the first and second element electrode structures 10 and 11 and the ground redistribution unit 15. The dielectric layer 20 may include a polymer material, although other suitable dielectric materials may also be used.

A ground electrode structure 25 may be provided on the dielectric layer 20. The ground electrode structure 25 may include a contact portion 25a passing through the dielectric layer 20 and electrically connected to the ground redistribution unit 15.

The ground electrode structure 25 may overlap one or more element electrode structures 10 and 11. For example, as illustrated in FIG. 2, the ground electrode structure 25 may include a first part to overlap a portion of the first element electrode structure 10, and another part to overlap a portion of the second element electrode structure 11.

The first element electrode structure 10 may include a first region IR_1 and a second region AR_1. Likewise, the second element electrode structure 11 may include a third region IR_2 and a fourth region AR_2. The first and third regions IR_1 and IR_2 may be in the shape of a line, and the second and fourth regions AR_1 and AR_2 may be in the shape of a polygon or a circle to have a larger width than the first and third regions IR_1 and IR_2. Since the first and third regions IR_1 and IR_2 have different widths from the second and fourth regions AR_1 and AR_2, a flat area taken by the first and second element electrode structures 10 and 11 may be minimized.

Referring to the example embodiment of FIGS. 2 and 3, a first overlapping area where the first element electrode structure 10 overlaps the ground electrode structure 25 may be determined by adjusting the length of the first region IR_1 of the first element electrode structure 10 or by adjusting the size of the second region AR_1. Likewise, a second overlapping region where the second element electrode structure 11 overlaps the ground electrode structure 25 may be determined by adjusting the length of the third region IR_2 of the second element electrode structure 11 or by adjusting the size of the fourth region AR_2.

Meanwhile, the first overlapping are where the first element electrode structure 10 overlaps the ground electrode structure 25 may be designed to have the same size as the second overlapping area where the second element electrode structure 11 overlaps the ground electrode structure 25.

A passivation layer 30 may be provided on the substrate having the ground electrode structure 25. First and second conductive structures 35 and 36 may be provided to pass through the passivation layer 30 and the dielectric layer 20, and to electrically connect to predetermined regions of the first and second element electrode structures 10 and 11. Also, a third conductive structure 40 may be provided to pass through the passivation layer 30 and the dielectric layer 20, and to electrically connect to the ground redistribution unit 15. In the meantime, the third conductive structure 40 may be provided to be in contact with the ground electrode structure 25.

In the example embodiment of FIGS. 2 and 3, the first element electrode structure 10 and the ground electrode structure 25, which overlap to face each other, and the dielectric layer 20 disposed therebetween may constitute an ESD protection device E1. Likewise, the second element electrode structure 11, the ground electrode structure 25 and the dielectric layer 20 disposed therebetween may form another ESD protection device. Therefore, since an electrode at one side of each ESD protection device is a ground electrode, a circuit or an element electrically connected to an element electrode at the other side may be protected from electrostatic discharge.

The ESD protection device according to the example embodiments can be formed on a chip CH or on an integrated circuit in the substrate W, and thus a flat area to design an ESD protection device is not required in the substrate W. Therefore, a flat area taken by the ESD protection device in an electronic device like a semiconductor chip, COF (chip on film), COG (chip on glass), flip-chip package or wire-bond package can be minimized.

The sizes of areas where the element electrode structures 10 and 11 overlap the ground electrode structure 25, and the thickness of the dielectric layer 20 may be configured to maintain an OFF state during the normal operation of a chip CH or an integrated circuit. In addition, the ESD protection device may be designed to operate only when electrostatic causes sudden and momentary voltage or current beyond the operation range of the chip or the integrated circuit to be generated.

In the example embodiment of FIGS. 2 and 3, the first to third conductive structures 35, 36 and 40 may be formed in a bump shape as illustrated in FIG. 3. However, the inventive concept is not limited hereto. For example, the first to third conductive structures 35, 36 and 40 may be formed in a ball structure shape. Furthermore, while each of the first to third conductive structures 35, 36 and 40 are illustrated to be formed at an edge portion of the chip region (CH in FIG. 2), the present general inventive concept is not limited thereto. For example, the bumps or the solder balls corresponding to the first to third conductive structures 35, 36 and 40 may be appropriately disposed at other locations of the substrate W, depending on the shape and/or purpose of a particular package.

FIG. 4 is a cross-sectional view of an electronic device according to another example embodiment of the present general inventive concept. Referring to FIG. 4, only a portion corresponding to the element electrode structure 10 of the plurality of element electrode structures 10 and 11 of FIG. 2 will be described to avoid obscuring the present general inventive concept in unnecessary detail. Referring to FIG. 4, unlike the ground electrode structure 25 of FIG. 3, a ground electrode structure 25′ according to the example embodiment of FIG. 4 may extend to a portion where the third conductive structure 40 of FIG. 3 would be disposed. Also, an element redistribution unit 27 may be disposed at the same level as the ground electrode structure 25′ on the dielectric layer 20. The element redistribution unit 27 may include a contact portion 27a to pass through the dielectric layer 20 and to electrically connect to the first element electrode structure 10. A passivation layer 30′ may be provided on the substrate having the ground electrode structure 25′ and the element redistribution unit 27. A conductive structure 35′ may be formed to pass through the passivation layer 30′ and to electrically connect to a predetermined region of the element redistribution unit 27, and a conductive structure 40′ may be formed to pass through the passivation layer 30′ and to electrically connect to a predetermined region of the ground electrode structure 25′. The conductive structures 35′ and 40′ may be appropriately disposed on the substrate depending on the shape and/or purpose of a package.

FIG. 5 is a cross-sectional view of an electronic device according to another example embodiment of the present general inventive concept. Referring to FIG. 5, a substrate W similar to that illustrated in FIG. 3 may be provided. An insulating layer 105 may be provided on the substrate W.

As illustrated in FIG. 5, an element redistribution unit 110 including contact portions 110a may be provided on the insulating layer 105 to pass through the insulating layer 105 and to electrically connect to input/output pads of the substrate. Also, a ground electrode structure 115 including a contact portion 115a may be provided to pass through the insulating layer 105 and to electrically connect to a ground region of the substrate W.

A dielectric layer 120 may be provided on the substrate having the element redistribution units 110 and the ground electrode structure 115. The dielectric layer 120 may include a polymer material.

One or more element electrode structures 125 may be provided on the dielectric layer 120. A part of each element electrode structure 125 can overlap the ground electrode structure 115, and another part 125a may pass through the dielectric layer 120 and may be electrically connected to the element redistribution units 110. Moreover, a ground redistribution unit 127 including a contact portion 127a may be provided on the dielectric layer 120 to pass through the dielectric layer 120 and to electrically connect to the ground electrode structure 115.

Referring to FIG. 5, the element electrode structures 125, the ground electrode structure 115 and the dielectric layer 120 disposed therebetween may form an ESD protection device E3 to protect a circuit or an element connected to a part (125a) of the element electrode 125 from electrostatic discharge.

As illustrated in FIG. 5, a passivation layer 130 may be provided on the substrate having the ESD protection device E3. In addition, conductive structures 135 may be provided to pass through the passivation layer 130 and to electrically connect to the element electrode structures 125. A conductive structure 140 electrically connected to the ground redistribution unit 127 may also be provided.

FIG. 6 is a plan view of a part of a wafer or a chip according to other example embodiments of the present general inventive concept, and FIG. 7 is a cross-sectional view taken along line II-II′ of FIG. 6.

Referring to FIGS. 6 and 7, a substrate 200 substantially similar to the substrate W of FIG. 3 may be provided. An insulating layer 205 may be provided on the substrate 200. A first element electrode structure 210 may be provided on the insulating layer 205.

A second element first redistribution unit 215 and a ground first redistribution unit 217, which are spaced apart from the first element electrode structure 210, may be provided on the insulating layer 205. The first element electrode structure 210 may be electrically connected to a first element of the substrate 200 by a contact portion 210a passing through the insulating layer 205, and the second element first redistribution unit 215 may be electrically connected to a second element of the substrate 200 by a contact portion 215a passing through the insulating layer 205. In the meantime, the ground first redistribution unit 217 may be electrically connected to a ground portion of the substrate 200 by a contact portion 217a passing through the insulating layer 205.

A first dielectric layer 220 may be provided to cover the first element electrode structure 210, the second element first redistribution unit 215, and the ground first redistribution unit 217. The first dielectric layer 220 may include a polymer material, although other dielectric materials may also be used.

A ground electrode structure 235 may be provided on the substrate having the first dielectric layer 220. The ground electrode structure 235 may include a contact portion to pass through the first dielectric layer 220 and to electrically connect to the ground first redistribution unit 217. Also, the ground electrode structure 235 may overlap a part of the first element electrode structure 210.

A first element first redistribution unit 225 and a second element second redistribution unit 230 may be disposed at substantially the same level as the ground electrode structure 235. The first element first redistribution unit 225 and the second element second redistribution unit 230 may be provided on the dielectric layer 220. In addition, the first element first redistribution unit 225 may include a contact portion 225a to pass through the dielectric layer 220 and to electrically connect to the first element electrode structure 210. Furthermore, the second element second redistribution unit 230 may include a contact portion 230a to pass through the dielectric layer 220 and to electrically connect to the second element first redistribution unit 215.

A second dielectric layer 240 may be provided on the substrate having the ground electrode structure 235, the first element first redistribution unit 225 and the second element second redistribution unit 230. The second dielectric layer 240 may include the same material as the first dielectric layer 220. Also, the second dielectric layer 240 may be formed to have the same thickness as the first dielectric layer 220.

A second element electrode structure 250 may be provided on the second dielectric layer 240. The second element electrode structure 250 may include a contact portion 250a to pass through the second dielectric layer 240 and to electrically connect to the second element second redistribution unit 230. Furthermore, the second element electrode structure 250 may overlap a part of the ground electrode structure 235 with the second dielectric layer 240 interposed therebetween.

Meanwhile, a first overlapping area between the first element electrode structure 210 and the ground electrode structure 235 may be substantially the same as a second overlapping area between the second element electrode structure 250 and the ground electrode structure 235.

Referring to FIGS. 6 and 7, a first element second redistribution unit 245 and a ground second redistribution unit 252 may be provided on the second dielectric layer 240. The first element second redistribution unit 245 and the ground second redistribution unit 252 may be disposed at substantially the same level as the second element electrode structure 250. The first element second redistribution unit 245 may include a contact portion 245a to pass through the second dielectric layer 240 and to electrically connect to the first element first redistribution unit 225. The ground second redistribution unit 252 may include a contact portion to pass through the second dielectric layer 240 and to electrically connect to the ground electrode structure 235.

In the example embodiment, the first element electrode structure 210, the ground electrode structure 235 and the first dielectric layer 220 disposed therebetween may form an ESD protection device E4 of the first element, and the second element electrode structure 250, the ground electrode structure 235 and the second dielectric layer 240 disposed therebetween may form an ESD protection device E5 of the second element.

Meanwhile, as illustrated in FIGS. 6 and 7, the first element electrode structure 210 may be formed to overlap the second element electrode structure 250 with the ground electrode structure 235 interposed therebetween. Therefore, a flat area taken by the ESD protection devices E4 and E5 in an electronic device such as a COP (chip on film), a COG (chip on glass), a flip-chip package, or a wire-bond package may be minimized.

A passivation layer 255 may be provided on the substrate having the second element electrode structure 250, the first element second redistribution unit 245 and the ground second redistribution unit 252. A first conductive structure 260 may be provided to pass through the passivation layer 255 and to be in contact with a predetermined region of the first element second redistribution unit 245. A second conductive structure 265 may be provided to pass through the passivation layer 255 and to be in contact with a predetermined region of the second element electrode structure 250. A third conductive structure 270 may be provided to pass through the passivation layer 255 and to be in contact with a predetermined region of the ground second redistribution unit 252. The first to third conductive structures 260, 265 and 270 may be formed in the shape of bumps or solder balls, although other shapes could also be used.

The present general inventive concept is not limited to the above-described example embodiments, but may also be specified as illustrated in FIGS. 8 and 9. For example, FIG. 8 is a plan view of a part of a wafer or a chip according to another example embodiment of the present general inventive concept, and FIG. 9 is a cross-sectional view taken along line III-III′ of FIG. 8.

Referring to FIGS. 8 and 9, a substrate 300 may be provided to include various elements (not illustrated) to be protected from electrostatic discharge. For example, the substrate 300 may be a semiconductor wafer where integrated circuits are formed or a wafer where one or more electronic chips are formed. As described herein, the integrated circuits and/or electronic chips may include elements connected to input/output pads of the substrate to be protected from electrostatic discharge. As illustrated in FIGS. 8 and 9, the substrate 300 may include pads 303, 305 and 307 formed on an upper region and an insulating protection layer 310 to cover the pads 303, 305 and 307.

In the present example embodiment, one of the pads may be defined as a ground pad, for example pad 303, which can be electrically connected to a ground region of the substrate 300. The other pads may be defined as a first input/output pad 305 and a second input/output pad 307, which can be electrically connected to various elements or circuits to be protected from electrostatic discharge.

An insulating layer 315 may be provided on the protection layer 310. Aground electrode structure 320 may be provided on the insulating layer 315. The ground electrode structure 320 may include a contact portion 320a to pass through the insulating layer 315 and the protection layer 310 and to electrically connect to the ground pad 303. A dielectric layer 330 may be provided on the substrate to cover the ground electrode structure 320. The dielectric layer 330 may include a polymer material, although other dielectric materials may also be used.

One or more element electrode structures may be provided on the dielectric layer 330. The element electrode structures may include a first element electrode structure 335 and a second element electrode structure 337. The first element electrode structure 335 may overlap a part of the ground electrode structure 320. Also, the first element electrode structure 335 may include a contact portion 335a to pass through the dielectric layer 330, the insulating layer 315 and the protection layer 310 to electrically connect to the first input/output pad 305.

The second element electrode structure 337 may overlap a part of the ground electrode structure 320. Also, the second element electrode structure 337 may include a contact portion 337a to pass through the dielectric layer 330, the insulating layer 315, and the protection layer 310 to electrically connect to the second input/output pad 307.

The first element electrode structure 335, the ground electrode structure 320 and the dielectric layer 330 disposed therebetween may constitute an ESD protection device E6. Likewise, the second element electrode structure 337, the ground electrode structure 320 and the dielectric layer 330 disposed therebetween may constitute another ESD protection device.

As illustrated in FIG. 9, a ground redistribution unit 333 may be disposed at substantially the same level as the first and second element electrode structures 335 and 337 on the dielectric layer 330. The ground redistribution unit 333 may be spaced apart from the first and second element electrode structures 335 and 337. The ground redistribution unit 333 may include a contact portion 333a to pass through the dielectric layer 330 and to electrically connect to the ground electrode structure 320.

A passivation layer 340 may be provided on the substrate having the first and second element electrode structures 335 and 337 and the ground redistribution unit 333. A plurality of conductive structures 343, 345 and 347 may be provided to pass through the passivation layer 340.

Exemplary methods of forming a structure of an electronic device according to example embodiments of the present general inventive concept will be described below.

A method of forming an electronic device according to an example embodiment of the present general inventive concept will be described with reference to FIGS. 1, 2 and 3.

Referring to FIGS. 1, 2, and 3, a substrate W including one or more elements to be protected from electrostatic discharge may be prepared. The substrate W may be a semiconductor wafer having chip regions CH where integrated circuits are formed or a wafer where one or more electronic chips are formed. The substrate may include a scribe lane region S between the chip regions CH. The integrated circuits and/or electronic chips may include elements to be protected from electrostatic discharge.

The wafer where one or more electronic chips are formed may be prepared by performing a semiconductor process using a semiconductor wafer to form an integrated circuit, performing a sawing process on the semiconductor wafer to separate the wafer into electronic chips including the integrated circuit, and attaching first chips and/or second chips among the separated chips to a substrate such as a rigid substrate or a flexible substrate.

An insulating layer 5 may be formed on the substrate W. However, when the surface of the substrate W is covered with an insulating material, an operation of forming the insulating layer 5 may be omitted.

In accordance with an example embodiment of the present general inventive concept, element electrode structures 10 and 11 and a ground redistribution unit 15 may be formed on the insulating layer 5. A method of forming the element electrode structures 10 and 11 and the ground redistribution unit 15 may include forming via holes to pass through the insulating layer 5 to expose predetermined regions of the substrate W using a damascene process, forming trenches to overlap the via holes in a predetermined region of the insulating layer 5, forming a conductive layer to fill the via holes and the trenches, and planarizing the conductive layer until the upper surface of the insulating layer 5 is exposed. Therefore, the upper surface of the substrate where the element electrode structures 10 and 11 and the ground redistribution unit 15 are formed may be planarized, that is, formed on substantially the same plane. The element electrode structures 10 and 11 may be electrically connected to the elements to be protected from electrostatic discharge in the substrate W.

The ground redistribution unit 15 may be electrically connected to a ground region of the substrate W through a contact portion 15a filling one of the via holes, and the first and second element electrode structures 10 and 11 may be electrically connected to the elements to be protected from electrostatic discharge through contact portions 10a and 11a filling the other via holes.

Meanwhile, a method of forming the ground redistribution unit 15 and the element electrode structures 10 and 11 may include patterning the insulating layer 5 to form the via holes to expose predetermined regions of the substrate W, forming a conductive layer on the substrate having the via holes, and patterning the conductive layer using photolithography and etching processes. In this case, a process of forming metal plugs to fill the via holes may be included after forming the via holes, and before forming the conductive layer.

In another example embodiment, the first and second element electrode structures 10 and 11 and the ground redistribution unit 15 may be final metal interconnections of integrated circuits formed on a silicon wafer.

A dielectric layer 20 may be formed on the substrate having the first and second element electrode structures 10 and 11 and the ground redistribution unit 15. The dielectric layer 20 may include a polymer material. The dielectric layer 20 may be formed using a spin coating process.

A ground electrode structure 25 including a ground electrode may be formed on the dielectric layer 20. The ground electrode structure 25 may include a contact portion 25a to pass through the dielectric layer 20 and to electrically connect to the ground redistribution unit 15.

The ground electrode structure 25 may overlap a plurality of element electrode structures 10 and 11. For example, the ground electrode structure 25 may include a first part to overlap a portion of the first element electrode structure 10 and another part to overlap a portion of the second element electrode structure 11. The ground electrode structure 25 may be in the shape of a plate, although other shapes may also be used.

Parts of the ground electrode structure 25 which overlap the first and second element electrode structures 10 and 11 may be defined as ground electrodes. Also, parts of the first and second element electrode structures 10 and 11 which overlap the ground electrode structure 25 may be defined as element electrodes.

The first element electrode structure 10 may include a first region IR_1 and a second region AR_1. Likewise, the second element electrode structure 11 may include a third region IR_2 and a fourth region AR_2 having different widths from each other. The first and third regions IR_1 and IR_2 may be in the shape of a line, and the second and fourth regions AR_1 and AR_2 may be in the shape of a polygon or a circle to have a larger width than the first and third regions IR_1 and IR_2.

In this example embodiment, a first overlapping area where the first element electrode structure 10 overlaps the ground electrode structure 25 may be determined by adjusting the length of the first region IR_1 of the first element electrode structure 10 and/or the size of a flat area of the second region AR_1. Likewise, a second overlapping region where the second element electrode structure 11 overlaps the ground electrode structure 25 may be determined by adjusting the length of the third region IR_2 of the second element electrode structure 11 and/or adjusting the size of a flat area of the fourth region AR_2.

Meanwhile, the first overlapping are where the first element electrode structure 10 overlaps the ground electrode structure 25 may be designed to have the same size as the second overlapping area where the second element electrode structure 11 overlaps the ground electrode structure 25.

A passivation layer 30 may be formed on the ground electrode structure 25. First and second conductive structures 35 and 36 may be formed to pass through the passivation layer 30 and the dielectric layer 20 to electrically connect to the first and second element electrode structures 10 and 11. Also, a third conductive structure 40 may be formed to pass through the passivation layer 30 and the dielectric layer 20 to electrically connect to the ground redistribution unit 15. In the meantime, the third conductive structure 40 may be formed to be in contact with the ground electrode structure 25.

The first element electrode structure 10, the ground electrode structure 25 and the dielectric layer 20 disposed therebetween may form an ESD protection device E1. Likewise, the second element electrode structure 11, the ground electrode structure 25 and the dielectric layer 20 disposed therebetween may form another ESD protection device. Therefore, since an electrode at one side of the ESD protection device is grounded, an element or circuit electrically connected to an element electrode at the other side of the ESD protection device may be protected from electrostatic discharge.

The ESD protection device according to the present example embodiment can be formed on the substrate W having a chip or an integrated circuit, and thus a separate flat area for designing the ESD protection device is not required in the substrate. Therefore, a flat area taken by the ESD protection device in an electronic device like a semiconductor chip can be minimized.

Also, since the ESD protection device according to the present example embodiment is not directly disposed on a path of an electric signal that is input into or output from a circuit or an element in the substrate W, delay in inputting/outputting an electric signal into/from the circuit or element in the substrate W may be minimized.

The sizes of areas where the element electrode structures 10 and 11 overlap the ground electrode structure 25, and the thickness of the dielectric layer 20 may be configured to maintain an OFF state of the ESD protection device during the normal operation of chips or integrated circuits in the substrate W. However, the ESD protection device may be designed in material, shape, and size to protect the chips and/or integrated circuits from electrostatic discharge when an electrostatic charge beyond a predetermined range of the chips and/or integrated circuits is generated.

In the example embodiment, the first to third conductive structures 35, 36 and 40 may be formed in a bump B shape illustrated in FIGS. 1 and 3. However, the inventive concept is not limited hereto. For example, the first to third conductive structures 35, 36 and 40 may be formed in a ball structure shape. Furthermore, while each of the first to third conductive structures 35, 36 and 40 is illustrated to be formed at an edge portion of the chip CH in FIG. 1, it is not limited hereto. For example, the bump or the solder ball corresponding to the first to third conductive structures 35, 36 and 40 may be appropriately disposed on other locations of the substrate W depending on the shape and/or purpose of a particular package.

The first and second conductive structures 35 and 36 may be input/output I/O_1 and I/O_2 terminals, and the third conductive structure 40 may be a ground Vss terminal.

The substrate W may be cut along a scribe lane region S of the substrate W. As a result, the chip regions CH of the substrate W may be separated from each other, so that a product such as a semiconductor package or a half-finished product may be formed. The separated semiconductor package may be formed on a substrate such as a printed circuit board in various shapes including a wire bonding shape or a flip chip shape to form an electronic device in the form of a product or a half-finished product.

Meanwhile, separating the chip regions CH of the substrate W may be performed before or after the first to third conductive structures 35, 36 and 40 are formed.

Methods of forming a substrate or a structure of an electronic device are not limited to the above-described example embodiments, but may also be specified with reference to FIG. 4. Here, only a portion of the method corresponding to one element electrode structure 10 among a plurality of element electrode structures 10 and 11 of FIG. 2 will be described to avoid obscuring the present general inventive concept in unnecessary detail.

Referring to FIG. 4, methods of forming the first element electrode structure 10 and the ground redistribution unit 15 on the substrate W, and forming the dielectric layer 20 on may be performed as described above with respect to embodiments of FIG. 3. However, different from FIG. 3, a ground electrode structure 25′ and an element redistribution unit 27 may be formed on the dielectric layer 20. Here, the element redistribution unit 27 may include a contact portion 27a to pass through the dielectric layer 20 to electrically connect to the first element electrode structure 10. Also, the ground electrode structure 25′ may include a contact portion 25a′ to pass through the dielectric layer 20 to electrically connect to the ground redistribution unit 15.

Then, a passivation layer 30′ may be formed on the substrate having the ground electrode structure 25′ and the element redistribution unit 27. A first conductive structure 35′ may be formed to pass through the passivation layer 30′ and to electrically connect to a predetermined region of the element redistribution unit 27, and a second conductive structure 40′ may be formed to pass through the passivation layer 30′ and to electrically connect to a predetermined region of the ground electrode structure 25′. The first and second conductive structures 35′ and 40′ may be formed in the shape of a bump or a solder ball to be appropriately disposed on the substrate W, although other shapes may also be used.

Meanwhile, as illustrated in FIG. 3, the substrate W may be cut along a scribe lane region S of the substrate W.

Methods of forming a substrate or a structure of an electronic device are not limited to the above-described example embodiments, but may also be specified with reference to FIG. 5. Referring to FIG. 5, a substrate W may be prepared as described above with respect to FIG. 3. An insulating layer 105 may be formed on the substrate W. Element redistribution units 110 and a ground electrode structure 115 may be formed on the insulating layer 105. The element redistribution units 110 may include contact portions 110a that pass through the insulating layer 105 to electrically connect to input/output pads of the substrate W. In addition, the ground electrode structure 115 may include a contact portion 115a that passes through the insulating layer 105 to electrically connect to a ground pad of the substrate W.

In some example embodiments, via holes may be formed to pass through the insulating layer 105 to expose element regions and a ground region of the substrate W using a damascene process. Trenches may be formed in a predetermined region of the insulating layer 105 to overlap the via holes. A conductive layer may be formed to fill the via holes and the trenches, and the conductive layer may be planarized until the upper surface of the insulating layer 105 is exposed, so that element redistribution units 110 and a ground electrode structure 115 may be formed. Therefore, the upper surface of the substrate where the element redistribution units 110 and the ground electrode structure 115 are formed may be planarized, that is, formed on substantially the same plane. The ground electrode structures 115 may be electrically connected to a ground region of the substrate W through a contact portion 115a filling the via hole, and the element redistribution units 110 may be electrically connected to the elements to be protected from electrostatic discharge through contact portions 110a filling the via holes.

A dielectric layer 120 may be formed on the substrate having the element redistribution units 110 and the ground electrode structure 115. The dielectric layer 120 may include a polymer material, although other dielectric materials may also be used.

Element electrode structures 125 may be formed on the dielectric layer 120. A part of the element electrode structures 125 can overlap a portion of the ground electrode structure 115, and another part, i.e., a contact portion 125a, may pass through the dielectric layer 120 to electrically connect to the element redistribution units 110.

While the element electrode structures 125 are being formed, a ground redistribution unit 127 including a contact portion 127a may be formed on the dielectric layer 120 to pass through the dielectric layer 120 and to electrically connect to the ground electrode structure 115.

The element electrode structures 125, the ground electrode structure 115 and the dielectric layer 120 disposed therebetween may form an ESD protection device E3.

A passivation layer 130 may be formed on the substrate having the ESD protection device E3. Conductive structures 135 may be formed to pass through the passivation layer 130 to electrically connect to the element electrode structures 125, and a conductive structure 140 may be formed to electrically connect to the ground redistribution unit 127.

Meanwhile, as described in FIG. 3, the substrate W may be cut along the scribe lane region S of the substrate W.

Methods of forming a substrate or a structure of an electronic device are not limited to the above-described example embodiments, but may also be specified with reference to FIGS. 6 and 7. FIG. 6 is a plan view of a part of a wafer or a chip according to another example embodiment, and FIG. 7 is a cross-sectional view taken along line II-II′ of FIG. 6.

Referring to FIGS. 6 and 7, a substrate 200 may be prepared as described above with respect to the substrate W of FIG. 3. An insulating layer 205 may be formed on the substrate 200. However, when the surface of the prepared substrate 200 is covered with an insulating material, an operation of forming the insulating layer 205 may be omitted.

A first element electrode structure 210 may be formed on the insulating layer 205. Meanwhile, while the first element electrode structure 210 is being formed, a second element first redistribution unit 215 and a ground first redistribution unit 217, which are spaced apart from the first element electrode structure 210, may be formed on the insulating layer 205.

The first element electrode structure 210 may be electrically connected to a first element of the substrate 200 through a contact structure 210a which passes through the insulating layer 205, and the second element first redistribution unit 215 may be electrically connected to a second element of the substrate 200 through a contact structure 215a which passes through the insulating layer 205. The ground first redistribution unit 217 may be electrically connected to a ground portion of the substrate 200 through a contact structure 217a which passes through the insulating layer 205.

A first dielectric layer 220 may be formed on the substrate having the first element electrode structure 210, the second element first redistribution unit 215, and the ground first redistribution unit 217. The first dielectric layer 220 may include a polymer material.

A ground electrode structure 235 may be formed on the substrate having the first dielectric layer 220. The ground electrode structure 235 may include a contact portion to pass through the first dielectric layer 220 and to electrically connect to the ground first redistribution unit 217. Also, the ground electrode structure 235 may overlap at least a part of the first element electrode structure 210.

Meanwhile, while the ground electrode structure 235 is being formed, a first element first redistribution unit 225 and a second element second redistribution unit 230 may be formed. The first element first redistribution unit 225 may include a contact portion 225a to pass through the dielectric layer 220 and to electrically connect to the first element electrode structure 210. Furthermore, the second element second redistribution unit 230 may include a contact portion 230a to pass through the dielectric layer 220 and to electrically connect to the second element first redistribution unit 215.

A second dielectric layer 240 may be formed on the substrate having the ground electrode structure 235, the first element first redistribution unit 225 and the second element second redistribution unit 230. The second dielectric layer 240 may include the same material as the first dielectric layer 220. Also, the second dielectric layer 240 may be formed to have the same thickness as the first dielectric layer 220.

A second element electrode structure 250 may be formed on the second dielectric layer 240. The second element electrode structure 250 may include a contact portion 250a to pass through the second dielectric layer 240 and to electrically connect to the second element second redistribution unit 230. Furthermore, the second element electrode structure 250 may overlap a part of the ground electrode structure 235 with the second dielectric layer 240 interposed therebetween.

Meanwhile, the second element electrode structure 250 may include a first region 250a and a second region 250b, which have different widths from each other. The second region 250b may have a greater width than the first region 250a. Likewise, the first element electrode structure 210 may include regions having different widths.

In the meantime, a first overlapping area between the first element electrode structure 210 and the ground electrode structure 235 may be substantially the same as a second overlapping area between the second element electrode structure 250 and the ground electrode structure 235.

While the second element electrode structure 250 is formed, a first element second redistribution unit 245 and a ground second redistribution unit 252 may be formed on the second dielectric layer 240. The first element second redistribution unit 245 may include a contact portion 245a to pass through the second dielectric layer 240 and to electrically connect to the first element first redistribution unit 225. Further, the ground second redistribution unit 252 may include a contact portion to pass through the second dielectric layer 240 and to electrically connect to the ground electrode structure 235.

In the present example embodiment, the first element electrode structure 210, the ground electrode structure 235 and the first dielectric layer 220 disposed therebetween may constitute an ESD protection device E4 of the first element of the substrate 200, and the second element electrode structure 250, the ground electrode structure 235 and the second dielectric layer 240 disposed therebetween may constitute an ESD protection device E5 of the second element of the substrate 200.

As illustrated in FIGS. 6 and 7, the first element electrode structure 210 may be formed to overlap the second element electrode structure 250 with the ground electrode structure 235 interposed therebetween. Accordingly, a flat area taken by the ESD protection devices E4 and E5 in an electronic device such as a package may be minimized.

A passivation layer 255 may be formed on the substrate having the second element electrode structure 250, the first element second redistribution unit 245 and the ground second redistribution unit 252. A first conductive structure 260 may be formed to pass through the passivation layer 255 and to be in contact with a predetermined region of the first element second redistribution unit 245. A second conductive structure 265 may be formed to pass through the passivation layer 255 and to be in contact with a predetermined region of the second element electrode structure 250. A third conductive structure 270 may be formed to pass through the passivation layer 255 and to be in contact with a predetermined region of the ground second redistribution unit 252. The first to third conductive structures 260, 265 and 270 may be formed in the shape of a bump or a solder ball.

Each of the first to third conductive structures 260, 265 and 270 may be appropriately disposed on the substrate W to be in the shape of a desired product, e.g., a semiconductor package.

Meanwhile, as described in FIG. 3, the substrate W may be cut along the scribe lane region of the substrate W.

The inventive concept is not limited to the described example embodiments, and may be specified as illustrated in FIGS. 8 and 9. FIG. 8 is a plan view of a part of a wafer or a chip according to yet other example embodiments, and FIG. 9 is a cross-sectional view taken along line III-III′ of FIG. 8.

Referring to FIGS. 8 and 9, a substrate 300 including elements to be protected from electrostatic discharge may be prepared. The substrate 300 may be substantially the same as the substrate W illustrated in FIG. 3. That is, the substrate 300 may be a wafer where integrated circuits are formed or a wafer where one or more electronic chips are formed. The integrated circuits and/or the electronic chips may include elements to be protected from electrostatic discharge.

The substrate 300 may include pads 303, 305 and 307 formed on an upper region, and an insulating protection layer 310 covering the pads 303, 305 and 307.

In the example embodiment, one of the pads may be defined as a ground pad 303 that is in the state of being grounded, and the others may be defined as a first input/output pad 305 and a second input/output pad 307, which are electrically connected to elements to be protected from electrostatic discharge.

An insulating layer 315 may be formed on the protection layer 310. Aground electrode structure 320 may be formed on the insulating layer 315. The ground electrode structure 320 may include a contact portion 320a to pass through the insulating layer 315 and the protection layer 310 and to electrically connect to the ground pad 303.

A dielectric layer 330 may be formed on the ground electrode structure 320. The dielectric layer 330 may be formed of a polymer material.

One or more element electrodes may be formed on the dielectric layer 330. The element electrodes may include a first element electrode structure 335 and a second element electrode structure 337. The first element electrode structure 335 may overlap a part of the ground electrode structure 320. Also, the first element electrode structure 335 may form a contact portion 335a to pass through the dielectric layer 330, the insulating layer 315 and the protection layer 310 to electrically connect to the first input/output pad 305.

The second element electrode structure 337 may overlap a part of the ground electrode structure 320. Also, the second element electrode structure 337 may include a contact portion 337a to pass through the dielectric layer 330, the insulating layer 315, and the protection layer 310 to electrically connect to the second input/output pad 307.

The first element electrode structure 335, the ground electrode structure 320 and the dielectric layer 330 disposed therebetween may constitute an ESD protection device E6. Likewise, the second element electrode structure 337, the ground electrode structure 320 and the dielectric layer 330 may constitute another ESD protection device.

While the first and second element electrode structures 335 and 337 are formed, a ground redistribution unit 333 may be formed on the ground electrode structure 320. The ground redistribution unit 333 may be spaced apart from the first and second element electrode structures 335 and 337. The ground redistribution unit 333 may include a contact portion 333a to pass through the dielectric layer 330 to electrically connect to the ground electrode structure 320.

A passivation layer 340 may be formed on the substrate having the first and second element electrode structures 335 and 337 and the ground redistribution unit 333. A plurality of conductive structures 343, 345 and 347 may be formed on the passivation layer 340 to pass through the passivation layer 340. As illustrated in FIG. 9, the conductive structures 343, 345 and 347 may be formed in the shape of a ball, a column or a pad, although other shapes may also be used.

According to the example embodiments described herein, an ESD protection device can be provided which does not increase a flat size of an electronic device. That is, since the ESD protection device can be formed on the substrate where an integrated circuit and/or an electronic chip is formed, the flat size of an electronic device adapting the ESD protection device is not increased.

Although a few embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

1. An electronic device comprising:
a substrate including a first element to be protected from electrostatic discharge (ESD);
a ground electrode disposed on the substrate;
a first element electrode disposed at a different level from the ground electrode on the substrate to overlap a part of the ground electrode and to electrically connect to the first element; and
a first dielectric layer disposed between the ground electrode and the first element electrode,
wherein the ground electrode, the first element electrode and the first dielectric layer disposed therebetween form an electrostatic discharge (ESD) protection device to connect the first element to ground when the ESD is applied to the first element.

2. The device of claim 1, wherein the first dielectric layer includes a polymer material.

3. The device of claim 1, further comprising a second element electrode disposed at the same level as the first element electrode and spaced apart from the first element electrode to overlap another part of the ground electrode with the first dielectric layer interposed therebetween,
wherein the second element electrode is electrically connected to a second element to be protected from electrostatic discharge in the substrate.

4. The device of claim 3, wherein the first element electrode includes a first region having a first width and a second region having a second width greater than the first width, and the second element electrode includes a third region having a third width and a fourth region having a fourth width greater than the third width, the second width being different from the fourth width.

5. The device of claim 1, wherein the ground electrode is disposed at a higher level than the first element electrode.

6. The device of claim 5, further comprising:
a third element electrode disposed at a higher level than the ground electrode and configured to overlap a part of the ground electrode; and
a second dielectric layer disposed between the third element electrode and the ground electrode,
wherein the third element electrode is electrically connected to a third element to be protected from electrostatic discharge in the substrate.

7. The device of claim 6, wherein the second dielectric layer includes the same material as the first dielectric layer.

8. The device of claim 6, wherein the second dielectric layer has the same thickness as the first dielectric layer.

9. The device of claim 6, wherein the first element electrode overlaps the third element electrode with the ground electrode interposed therebetween.

10. The device of claim 1, wherein the first element electrode constitutes a top metal interconnection of the first element.

11. The device of claim 1, wherein the first element electrode is disposed at a higher level than the ground electrode.

12. The device of claim 1, further comprising a ground redistribution unit disposed at the same level as the first element electrode,
wherein the ground redistribution unit is electrically connected to the ground electrode through a contact portion configured to pass though the first dielectric layer.

13. The device of claim 1, further comprising a first element redistribution unit disposed at the same level as the ground electrode,
wherein the first element redistribution unit is electrically connected to the first element electrode through a contact portion configured to pass through the first dielectric layer.

14-23. (canceled)

24. An electrostatic discharge protection device, comprising:
a ground electrode disposed on a first level of a substrate;
a first element electrode disposed on a second level of the substrate different from the first level and having a first part to overlap a portion of the ground electrode and a second part to electrically connect to one or more electronic elements installed to the substrate; and
a first dielectric layer disposed between the ground electrode and the first element electrode to connect the one or more electronic components to ground when a charge beyond a predetermined range is applied to the one or more electronic elements.

25. The device of claim 24, further comprising:
a second element electrode disposed at a different level from the first element electrode and the ground electrode and having a first part to overlap a portion of the ground electrode and a second part to electrically connect to another electronic element installed to the substrate; and
a second dielectric layer disposed between the ground electrode and the second element electrode to connect the another electronic element to ground when a charge beyond a predetermined range is applied to the another electronic element.

26. The device of claim 25, wherein at least a portion of the first and second element electrodes overlap each other.

27. The device of claim 24, wherein the second part is electrically connected to an input/output (I/O) pad of the substrate to connect the one or more electronic elements.

28. The device of claim 24, wherein the first part has a polygon or circular shape and the second part has a linear shape, and wherein a width of the second part is less than a width of the first part.

29. The device of claim 24, further comprising:
a signal path disposed on the substrate to input or output a signal to the one or more electronic elements,
wherein the signal path is disposed away from the ground electrode, the first element electrode, and the first dielectric layer.

30-34. (canceled)
